(19) United States
(12) Patent Application Publication
(10) Pub. No.: US 2005/0138211 A1
(43) Pub. Date: Jun. 23, 2005

(54) Data synchronization system with data security and proxy capabilities

(75) Inventor: Jen-Po Cheng, Taipei (TW)

Correspondence Address: VENABLE, BAETJER, HOWARD AND CIVILETTI, LLP, P.O. BOX 34385, WASHINGTON, DC, 20043-9998, US

(73) Assignee: Mobile Action Technology Inc., Taipei Hsien (TW)

(21) Appl. No.: 10/739,194

(22) Filed: Dec. 19, 2003

(51) Int. Cl. G06F 15/16

(52) U.S. Cl. 709/250

(57) ABSTRACT

A modified data synchronization system having data security and proxy capabilities has a delivery server, a PC, and at least one mobile phone. The PC sends out the exchange data through the Internet to a remote location where the delivery server is installed, and then one mobile phone compliant with SyncML protocols dials in to conduct data synchronization with the delivery server through wireless means, through which the existing data discrepancy between the mobile phone and the PC can be eliminated. The PC does not need to install a dedicated SyncML server, and data security can be ensured in the synchronization process, as data transfer between the PC and the delivery server through secured protocol over the Internet, and that between the mobile phone and the delivery server is through a dedicated channel.

### BACKGROUND OF THE INVENTION

1. Field of the Invention

The present invention is related to a data synchronization system having data security and proxy capabilities, in particular to a modified data synchronization system that can be installed in between a plurality of mobile phones and a PC to enable data synchronization with secured data transmission. Under the present system, the data copy in the PC can be synchronized through an Internet connection, with no need of a dedicated SyncML server.

2. Description of Related Art

To conduct e-business or e-commerce, companies and individuals have to rely heavily on computers to record their business or personal data such as address books, work calendars, reminders, and memos, but out on the road, mobile users like sales personnel, businessmen, and field technicians have to use portable data communications devices like notebook PC, mobile phones and PDAs to accomplish the same tasks as in the office. A data mobility problem may be created at this point in that the copy of data kept in the computer and in the portable device might not be the same. The latest copy of data is often found in the portable device, because the mobile user has not had the chance to update the original copy of data in the computer or vis vesa. Therefore, a data discrepancy may be produced, which could some times render the original information either in the computer or in the portable device totally useless.

According to current practices, there are two ways to solve the above mentioned data mobility problem: one way is to have a direct linkage between the portable device and the computer by means of a transmission line, infra red means, or by Blue Tooth™ to allow the portable device to be connected to the computer to conduct data synchronization; the other way is to make use of a wireless communications network to log onto the server through the Internet.

The first method has the advantages of one-to-one connection, simple implementation, and data security. However, the portable device, the computer and the transmission line all have to be available at the same time to consummate the data synchronization. For field personnel or businessmen, who often carry the portable devices with them for days or even weeks, this method of carrying PC and transmission cable is cumbersome and impractical.

For the second method of using a wireless communications network to log onto the server through the Internet, the mobile user only needs to install client-end data sync driver in the mobile phone to become a SyncML™ client, so that the mobile user through the SyncML client can log on to the SyncML™ server for the requested data synchronization.

As background information, Synchronization Markup Language (SyncML™) is a data synchronization protocol, developed by the Open Mobile Alliance (OMA). SyncML is an open standard that can be used to establish a data synchronization scheme for communications between devices, applications and networks. SyncML data sync scheme ensures that a consistent set of data is always available on any device or application at any time, and it has the capability of administering remote devices through wireless means.

The above mentioned second method can correct the problem encountered by the first method using a direct linkage, and it is a fast and simple way for mobile users who need to work with a mobile phone or PDA out on the road. To fulfill these needs, many manufacturers of mobile phones have incorporated SyncML drivers in the controller chips to enable a client-server linkage.

All SyncML servers, compliant with SyncML protocols, have set aside port 80 in HTTP protocols to receive incoming requests from SyncML clients (which could be a mobile phone or PDA) asking for data synchronization.

However, this conventional SyncML data sync model still has the following disadvantages:

Firstly, if the mobile user intends to use the data copy on the mobile phone to update the computer in the data synchronization, then the computer has to be installed with a SyncML server. Further, the SyncML server has to be always on standby to retrieve any data records such as address books and work calendars when a data synchronization request is received;

Secondly, the SyncML server needs to be assigned a fixed IP address. For a home office or small business concern, the end user often chooses to use a modem to uplink to the Internet or ADSL with a dynamically assigned IP address, so it is more difficult to set up a dedicated server since there is no fixed IP address for this person.

For those that do possess a fixed IP address, the linkage model between a mobile phone and a computer is often like this: the mobile phone based on General Packet Radio Service (GPRS) initiates a call to establish a link through a wireless applications protocols (WAP) gateway of the service provider, which are routed through the Internet, using hypertext transfer protocols (HTTP); it then reaches the SyncML server; and then the SyncML server establishes a network link for the requested data synchronization. In the data transfer process, plain text is used by the HTTP protocols, but it lacks the proper encryption to protect the confidentiality of the user information, which makes it liable to be intercepted by network miscreants over the Internet.

### SUMMARY OF THE INVENTION

The main object of the present invention is to provide a modified data synchronization system that possesses data security and proxy capabilities, without using a dedicated SyncML server, whereby the data synchronization can be conducted with secured data transmission between the mobile phones and the PC.

To this end, the architecture of the data synchronization system under the present invention includes a delivery server, more than one mobile phone, and a PC.

The delivery server is composed of a communication manager, a synchronization manager, and a dynamic data storage.

The delivery server, which is implemented by a proxy server compliant with the SyncML protocols, is embedded with read/write instructions for processing data coming from the PC through the Internet and new data from the mobile phone, wherein the dynamic data storage is provided for temporary saving of exchanged data for subsequent data synchronization compliant with the SyncML protocols, and the delivery server is connected to the switching system by a dedicated line.

The PC, which can be a personal computer, is embedded with a network user interface and a remote-end net driver, wherein the network user interface serves as the software interface between the mobile user and the delivery server, and the remote-end net driver is used to make connection to the delivery server through the Internet for uploading or downloading of data.

More than one mobile phone, which can be mobile phones or PDAs compliant with SyncML protocols, each has a mobile user interface which enables wireless communications through a WAP gateway provided by a service provider to make the necessary connection with the delivery server for the data synchronization, after which updated data are downloaded to the PC to consolidate the original data.

It shall be noted that the uplink from the mobile phone to the delivery server is through a dedicated channel, without routing through the Internet, so as to prevent illegal stealing of the data by network miscreants.

The first stage of data synchronization under the present invention includes the steps of:
connecting the PC and the delivery server through the Internet to allow the PC to pass over the exchange data, and at the same time checking whether the delivery server has new data for downloading to the PC from the previous data synchronization; and
connecting the mobile phone that supports data synchronization (SyncML) protocols to the delivery server by means of wireless communications to allow the mobile phone to forward any new data to the delivery server, so that the delivery server will be able to conduct data synchronization using exchanged data in the dynamic data storage, and later with the PC.

When the first stage of data synchronization is finished, the delivery server sends out a short message through the messenger of the service provider to the mobile user of the mobile phone, requesting the mobile phone to prepare for the second stage of data synchronization, in which the latest copy of exchange data, or updated data is downloaded to the PC through a network connection routed through the Internet to consolidate with the data set in the PC.

When the second stage of data synchronization is finished, whereby the data in the mobile phone and the PC are in sync, the existing copy of exchanged data in the delivery server can then be deleted from the dynamic data storage of the delivery server automatically, so as to create space for new data. Therefore, the personal data of the mobile user will only be temporarily provided to the delivery server for use in the data synchronization, so the personal data will not be kept on server, and that the data transfer is implemented with secured line such as high security SSL protocols.

According to the system design, the PC can also initiate an inquiry to the delivery server to check whether the exchange data has been retrieved and updated by the mobile phone. If indeed retrieved and updated, the PC then asks the delivery server whether any updated data is available for downloading.

On the other hand, when changes are made to the data set in the PC unilaterally, the PC needs to forward the portion of changed data to the delivery server.

Other objectives, advantages and novel features of the invention will become more apparent from the following detailed description when taken in conjunction with the accompanying drawings.

### BRIEF DESCRIPTION OF THE DRAWINGS

FIG. 1 is system block diagram of the present invention; and

FIG. 2 is a flow chart of the procedures adopted by the present system.

### DETAILED DESCRIPTION OF THE PREFERRED EMBODIMENT

Under the present invention, a modified data synchronization system having data security and proxy capabilities is installed in between PCs and a mobile phone, whereby two different copies of data containing information such as address books, work calendars, task schedules, memo pads, and emails separately kept in the mobile phone and the PC can be synchronized, wherein the mobile phone is loaded with a SyncML driver to allow the mobile phone to be connected to a delivery server through a wireless communication network for the requested data synchronization.

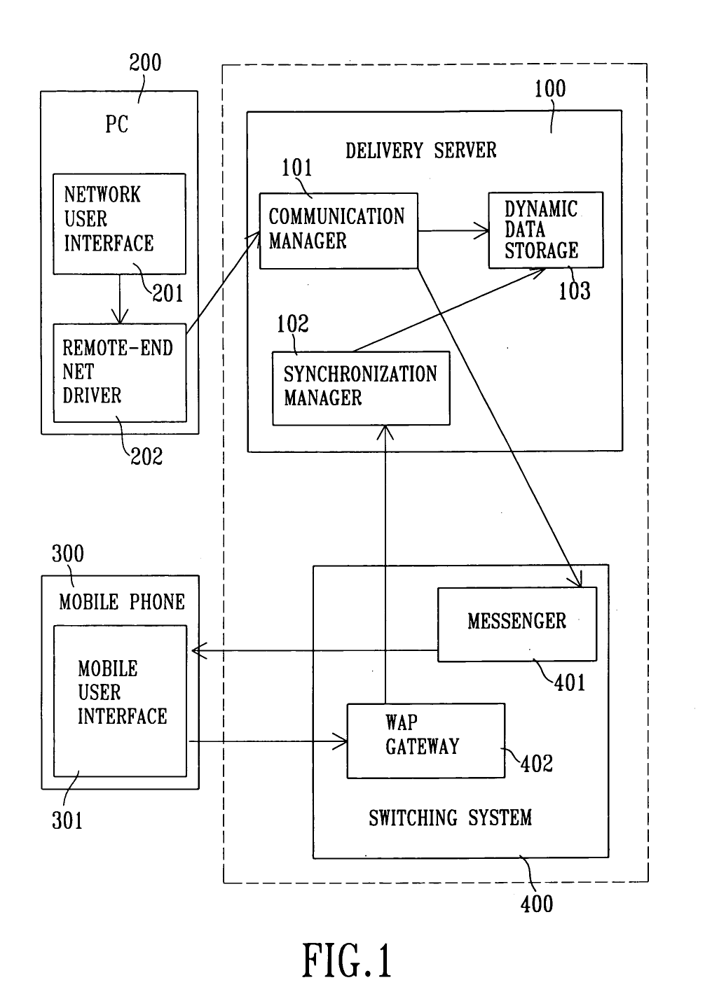

The basic structure of the modified data synchronization system under the present invention, as shown in FIG. 1, includes a delivery server (100), a PC (200), and more than one mobile phone (300).

The delivery server (100), which is implemented by a proxy driver, includes a communication manager (101), a dynamic data storage (103), and a synchronization manager (102). These three components of the delivery server (100) can be independent from each other, or combined into one and installed at one location in the proxy server, wherein the communication manager (101) receives access requests from the PC (200) through the Internet, and the dynamic data storage (103) is used for temporarily saving of exchanged data from the PC (200) and new data from the mobile phones (300) to allow the synchronization manager (102) to conduct data synchronization accordingly, compliant with SyncML protocols, on both ends through a dedicated line connected to the switching system (400).

The delivery server (100) is embedded with data read/write instruction set for retrieving exchanged data from the PC (200) through the Internet on one end, and for receiving new data from the mobile phones (300) on the other end.

The PC (200), which can be a personal computer, is embedded with a network user interface (201) and a remote-end net driver (202), wherein the network user interface (201) is used to set up the necessary interface for the PC (200) to be connected to the delivery server (100), and the remote-end net driver (202), also resident in the PC (200), is responsible for the network link, wherein the network user interface (201) and the remote-end net driver (202) can be independent components, or combined into one software driver.

The mobile phone (300), which can be a mobile phone or PDA, is built in with a mobile user interface (301) that supports SyncML protocols to allow the mobile user of the mobile phone to be connected by wireless means to a synchronization manager (102) for the requested data synchronization.

The switching system (400) has a messenger (401) and a wireless applications protocols (WAP) gateway (402).

Under the architecture of the data synchronization system, the PC (200) does not include a dedicated SyncML server; instead, it is connected to the delivery server (100) through the Internet, therefore the PC (200) does not require a fixed IP address.

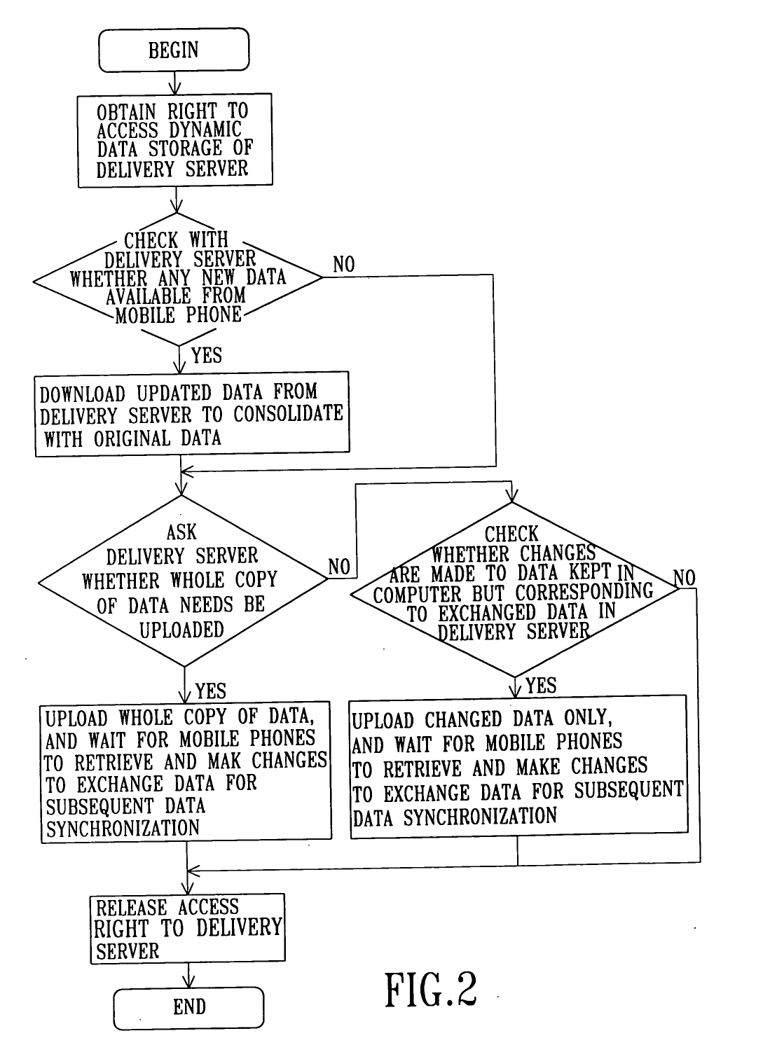

In actual application of the present system, as shown in FIG. 2, the PC (200) is first logged onto the delivery server (100) to obtain the access right; after successful certification, the PC (200) initiates a request to the communication manager (101) to check whether any new data is received from the mobile phone (300) which is temporarily stored in the dynamic data storage (103); if stored, the new data is downloaded to the PC (200) for updating the original data in the PC (200); if not stored, in the case of no new data from the mobile phone (300), data for exchange is selected by the PC (200) and then uploaded to the delivery server (100). For first-time data uploading, the whole copy of data kept in the PC (200) is forwarded to the delivery server (100), and temporarily saved in the dynamic data storage (103); for second-time and successive uploading, only the part of data set that has been changed needs to be forwarded. After receiving the data from the PC (200), the communication manager (101) will wait for any new data from the mobile phone (300) and then will send a short message to the PC (200) through the messenger (401) to notify that the updated data is available from the mobile phone (300) for downloading.

For the PC (200), in data uploading and downloading, the network user interface (201) and the remote-end net driver (202) are activated to set up the network link through the Internet, and then to transmit data to or receive data from the delivery server (100) with proper data security such as SSL protocols to prevent the stealing of confidential data content in the data transmission.

The mobile phone (300) relies on the mobile user interface (301) to make connection to the delivery server (100) through the WAP gateway (402) of the switching system (400). In the connection process, the mobile phone (300) is first connected to the synchronization manager (102) through the WAP gateway (402), and then the synchronization manager (102) fetches the copy of exchanged data containing address books and work calendars from the dynamic data storage (103) originated from the PC (200) for comparison with the new data. If new data is found to be different from the exchanged data, the data will be update by the synchronization manager (102) in one process, and the most recent copy of exchanged data will be kept in the dynamic data storage (103) for subsequent downloading by the PC (200).

Since the synchronization manager (102) is connected to the switching system (400) by a dedicated line, new data coming in from the mobile phone (300) through the WAP gateway (402) can be passed directly to the synchronization manager (102) for comparison with the existing copy of exchanged data read from the dynamic data storage (103). Therefore the data transfer is not routed through the Internet, preventing stealing of data over the Internet.

Another feature of the present system is that the PC (200) is not limited to the passive functions, and can also initiate an inquiry to the delivery server (100), that means the remote-end net driver (202) will periodically check with the communication manager (101) whether the uploaded data has been retrieved by the mobile phone (300). If retrieved, then the remote-end net driver (202) will ask the communication manager (101) whether the mobile phone (300) has updated the original data; if updated, the PC (200) will initiate downloading of the updated data for synchronizing the original data in the computer.

After the PC (200) and the mobile phone (300) have used and completed the first and second stage of data synchronization, the existing copy of exchanged data in the dynamic data storage (103) will be deleted automatically.

Under the present scheme, data synchronization is executed with a predetermined time interval to keep the data copy in the PC and the mobile phones always in sync, and the data synchronization and data transmission are particularly secure because all network communications are implemented with high security line such as SSL protocols to prevent data tampering or stealing in the data transmission path, and the exchanged data in the data storage of the delivery server will be automatically deleted after the data synchronization is completed.

It shall be noted that the PC does not need a dedicated SyncML server, as compared with the conventional data synchronization methods.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A modified data synchronization system having data security and proxy capabilities, comprising a delivery server (100), a PC (200) and at least one mobile phone (300), wherein
the delivery server (100), which is implemented by a proxy server compliant with SyncML protocols, is composed of a communication manager (101), a synchronization manager (102), and a dynamic data storage (103); and
the delivery server (100) is embedded with a data read/write instruction set to allow the communication manager (101) to receive the exchange data from the PC (200) through the Internet, and has the dynamic data storage (103) for temporarily saving the exchange data to allow the synchronization manager (102) to be connected to the at least one mobile phone (300) through the switching system (400) to conduct data synchronization compliant with SyncML protocols;
the PC (200) is embedded with a network user interface (201) and a remote-end net driver (202), wherein the network user interface (201) is to set up the interface to be connected to the delivery server (100) for uploading and downloading of requested data for use in data synchronization; and
the at least one mobile phone (300) is built in with a mobile user interface (301) that can support the SyncML protocols, such that the mobile user of the at least one mobile phone (300) can be connected by a WAP gateway provided by the service provider to the synchronization manager (102) for the requested data synchronization.

2. The modified data synchronization system as claimed in claim 1, wherein the data transfer between the PC (200) and the delivery server (100) is routed through the Internet with secured data transmission.

3. The modified data synchronization system as claimed in claim 1, wherein the data transfer between the switching system (400) and the delivery server (100) is conducted through a dedicated channel of the service provider without routing through the Internet.

4. The modified data synchronization system as claimed in claim 1, wherein the existing copy of the exchanged data in the dynamic data storage (103) of the delivery server (100) is to be deleted automatically after the data synchronization is completed to ensure data confidentiality.

5. The modified data synchronization system as claimed in claim 1, wherein after receiving data copy from the PC (200), the delivery server (100) sends a short message to the at least one mobile phone (300) notifying the mobile phone to prepare for data synchronization.
